(19) United States
(12) Patent Application Publication
(10) Pub. No.: US 2014/0122912 A1
(43) Pub. Date: May 1, 2014

(54) INFORMATION PROCESSING APPARATUS AND OPERATION CONTROL METHOD

(71) Applicant: KABUSHIKI KAISHA TOSHIBA, Tokyo (JP)

(72) Inventors: Hideaki Andou, Ome-shi (JP); Tsukasa Nunami, Ome-shi (JP)

(21) Appl. No.: 13/944,064

(22) Filed: Jul. 17, 2013

(30) Foreign Application Priority Data
Oct. 25, 2012 (JP) 2012-235993

(51) Int. Cl. G06F 1/32

(52) U.S. Cl. CPC G06F 1/3265
USPC 713/324

(57) ABSTRACT

According to one embodiment, an information processing apparatus detects whether or not a person is in front of a screen of a display arranged on a front surface of a second housing. When the second housing is set at a first position where the screen of the display and an upper surface of a first housing are exposed, the apparatus enables a control function for controlling a state of the display to transit from an ON state to an OFF state based on the detection result. When the second housing is set at a second position where the screen of the display is exposed and at least a part of the upper surface is covered with a back surface of the second housing, the apparatus disables the control function.

### CROSS-REFERENCE TO RELATED APPLICATIONS

This application is based upon and claims the benefit of priority from Japanese Patent Application No. 2012-235993, filed Oct. 25, 2012, the entire contents of which are incorporated herein by reference.

### FIELD

Embodiments described herein relate generally to an information processing apparatus and an operation control method applied to the apparatus.

### BACKGROUND

In recent years, various portable personal computers such as laptop type or notebook type computers have been developed.

Also, a technique for extracting a face image of a user from an image captured by a camera to determine whether or not a computer is in use, and starting power control for setting the computer in a suspend state when the computer is not in use has been developed.

However, when such control is always enabled, the power control of the computer is unwantedly started although the user uses the computer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearances respectively corresponding to three modes of an information processing apparatus according to an embodiment.

FIG. 2 is an exemplary view for explaining the relationship between a base unit and display unit provided to the information processing apparatus according to the embodiment.

FIG. 3 is an exemplary view for explaining style transition processes from a laptop mode to a tablet mode of the information processing apparatus according to the embodiment.

FIG. 4 is an exemplary block diagram showing the system arrangement of the information processing apparatus according to the embodiment.

FIG. 5 is an exemplary block diagram showing the configuration of an active display OFF application program executed by the information processing apparatus according to the embodiment.

FIG. 6 is an exemplary flowchart showing the sequence of display state control processing executed by the active display OFF application program shown in FIG. 5.

FIG. 7 is an exemplary flowchart showing the sequence of display state control enable/disable processing executed by the active display OFF application program shown in FIG. 5.

FIG. 8 is an exemplary view for explaining a condition under which execution of the display state control is permitted when the information processing apparatus according to the embodiment is in the tablet mode.

### DETAILED DESCRIPTION

Various embodiments will be described hereinafter with reference to the accompanying drawings.

In general, according to one embodiment, an information processing apparatus includes a first housing having an upper surface on which a keyboard is arranged, a second housing having a front surface on which a display is arranged, a detector, and a controller. The detector detects whether or not a person is in front of a screen of the display. When the second housing is set at a first position where the screen of the display and the upper surface are exposed, the controller enables a control function for controlling a state of the display to transit from an ON state to an OFF state based on a detection result of the detector. When the second housing is set at a second position where the screen of the display is exposed and at least a part of the upper surface is covered with a back surface of the second housing, the controller disables the control function.

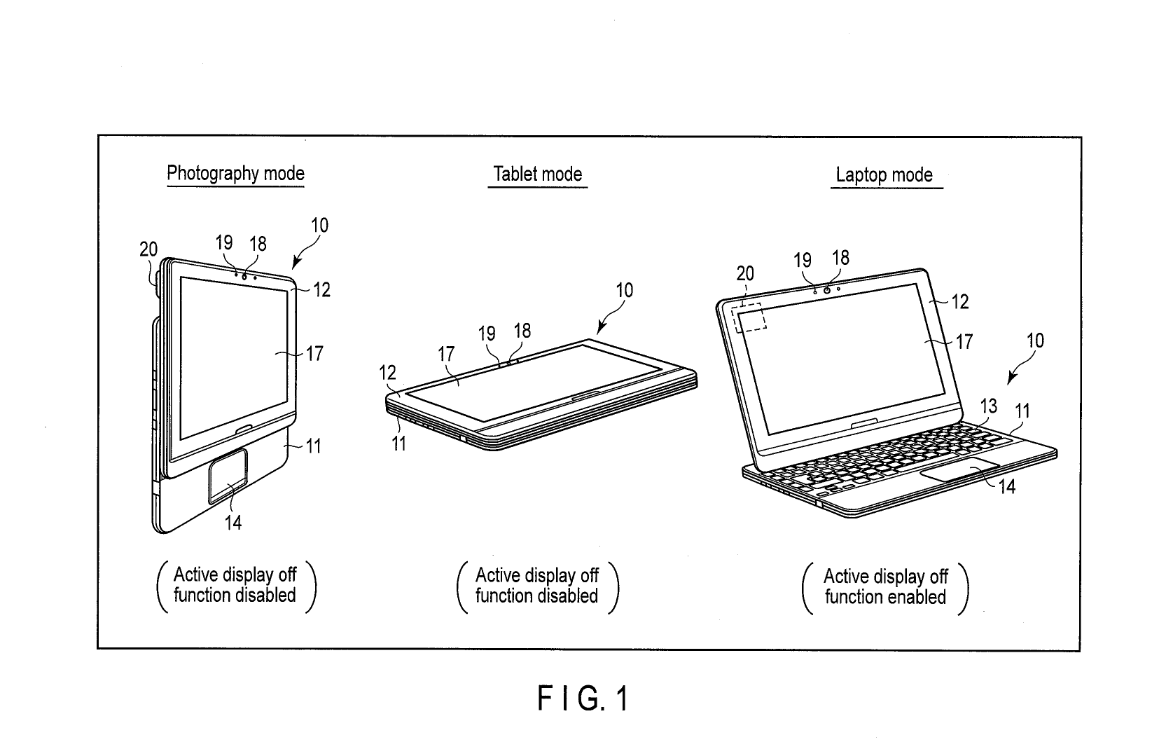

FIG. 1 shows the outer appearances corresponding to three modes (styles), that is, a laptop mode, tablet mode, and photography mode of an information processing apparatus according to one embodiment. This information processing apparatus is implemented as, for example, a convertible computer 10. The convertible computer 10 is used in a style corresponding to any one of the laptop mode shown on the right side of FIG. 1, the tablet mode shown on the center of FIG. 1, and the photography mode shown on the left side of FIG. 1.

This convertible computer 10 includes a base unit 11 and display unit 12. The base unit 11 has a low-profile rectangular housing (first housing) which houses a CPU, memory, and various other electronic components. A keyboard 13 and touch pad 14 as a pointing device are arranged on the upper surface of the base unit 11. The touch pad 14 is arranged on a palm rest region located at the front end portion on the upper surface of the base unit 11.

The display unit 12 also has a low-profile rectangular housing (second housing). On the front surface of the display unit 12, a display 17 is arranged so that its display surface is located on the front surface of the display unit 12. This display 17 is implemented by a touch screen display which can detect a position of a pen or finger on the screen of the display 17. A camera (Web camera) 18 is arranged on the upper end portion on the front surface of the display unit 12. This camera 18 can capture an image (moving image or still image) of the front side of the display unit 12. The user can capture a moving image or can take a picture using the camera 18. On the upper end portion on the front surface of the display unit 12, for example, near the camera 18, an LED indicator 19 is arranged. The LED indicator 19 is lighted while the camera 18 is active, so as to notify the user that the camera 18 is active.

Furthermore, a camera 20 is also arranged on the upper end portion on the back surface of the display unit 12. This camera 20 can capture an image (moving image or still image) of the back surface side of the display unit 12. The user can capture a moving image or can take a picture using the camera 20.

In this embodiment, the camera 18 is used to execute an active display OFF function. This active display OFF function is the following control function. That is, this function detects, using the camera 18, whether or not a person is in front of the screen of the display 17. When no person is in front of the screen of the display 17, the function automatically turns off the display 18. The front of the screen of the display 17 means a capture range of the camera 18.

Furthermore, the active display OFF function can also automatically turn on the display 17 when it detects a person who is in front of the display 17 during a period in which the display 17 is OFF. When this active display OFF function is enabled, while the person is in front of the computer 10, even when an input operation by the user is not made for a predetermined period, the screen of the display 17 is never turned off. This active display OFF function detects a face image of a person from an image captured by the camera 18. When the face image is detected, it is determined that a person is in front of the screen of the display 17.

The display unit 12 is set at a first position corresponding to the style of the laptop mode shown on the right side of FIG. 1, or at a second position corresponding to the style of the tablet mode shown on the center of FIG. 1 or that of the photography mode shown on the left side of FIG. 1. More specifically, the display unit 12 is set at one of the aforementioned first position (laptop mode) where the screen of the display 17 and the upper surface of the base unit 11 are exposed and the aforementioned second position (tablet mode or photography mode) where the screen of the display 17 is exposed, and at least a part of the upper surface of the base unit 11 is covered with the back surface of the display unit 12.

In the laptop mode, the convertible computer 10 is mainly used in a state in which it is placed on, for example, a horizontal surface such as a desktop. The user is on a chair in front of a desk on which the convertible computer 10 is placed, and mainly operates the keyboard 13 like in a normal notebook computer. In this case, the face of the user is normally located on the front surface side of the screen of the display 17. Therefore, in this embodiment, the active display OFF function is set to be enabled in the laptop mode.

On the other hand, in the tablet mode, the display unit 12 is set at a position where the screen of the display 17 is exposed, and the upper surface of the base unit 11 is fully covered with the back surface of the display unit 12. In this tablet mode, the convertible computer 10 is mainly used in a state in which it is held by one or both the hands of the user. The user holds the convertible computer 10 by, for example, one arm, and makes a touch operation on the display 17 using the other hand.

In the photography mode, only a part of the upper surface of the base unit 11 is covered with the back surface of the display unit 12. That is, in the photography mode, the display unit 12 is set at a position where, for example, the screen of the display 17 is exposed, at least a part of the upper surface of the base unit 11 is covered with the back surface of the display unit 12, and the touch pad 14 is exposed. In this photography mode, the camera 20 on the back surface of the display unit 12 is also exposed. For this reason, the user can use the photography mode so as to take a picture using the camera 20. The user can take a picture using the camera 20 while holding the convertible computer 10 by one or both the hands. In a photographing operation using the camera 20, the display 17 can function as an electronic viewfinder. Alternatively, the convertible computer 10 in the photography mode may be used while being placed on the desktop with the screen of the display 17 facing upward. The user can not only make a touch operation on the display 17, but also can operate the touch pad 14.

During the tablet mode or photography mode, the user's face is not normally located on the front side of the screen of the display 17 in a use scene. Furthermore, in the tablet mode or photography mode, since the user uses the convertible computer 10 while holding it by one or both the hands, the user's face position falls outside the capturing range of the camera 18, that is, a frame-out state readily occurs. Also, when the convertible computer 10 in the tablet mode or photography mode is placed on the desktop with the screen of the display 17 facing upward, the aforementioned frame-out state readily occurs.

For this reason, in the tablet mode or photography mode, when the active display OFF function is kept enabled, the screen may be turned off even when the user is using the convertible computer 10, thus causing a trouble.

Thus, in this embodiment, the style change of the computer 10 is detected, and when the mode (for example, the photography mode or tablet mode) other than the laptop mode is set, the active display OFF function is automatically switched to be disabled. Furthermore, when the laptop mode is set again, the active display OFF function is automatically switched to be enabled.

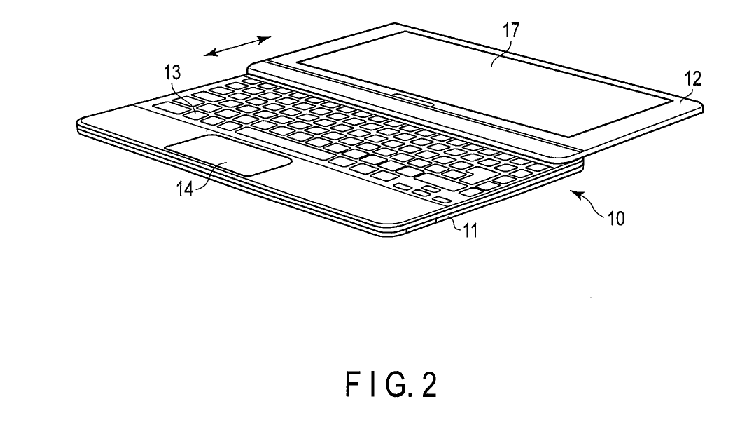

FIG. 2 shows an example of the relationship between the base unit 11 and display unit 12. The display unit 12 is attached to support members (hinges) arranged on the rear end portion of the base unit 11, so that its display surface is nearly parallel to the upper surface of the base unit 11, that is, the display unit 12 is opened through nearly 180°. In the state in which the display unit 12 is opened through nearly 180°, only the upper end portion of the base unit 11 is covered with the back surface of the display unit 12.

Furthermore, the display unit 12 is attached to the base unit 11, so as to be movable (slidable) between the front end portion and rear end portion of the base unit 11. As a mechanism required to slide the display unit 12, various mechanisms can be used. For example, guide rails (grooves), which extend from the lower end portion toward the upper end portion of the display unit 12 may be formed on the back surface of the display unit 12. Furthermore, the support members (hinges) on the rear end portion of the base unit 11 may be slidably engaged with the guide rails. In this manner, in the state in which the display unit 12 is opened through nearly 180°, the display unit 12 can be freely slidable between the front end portion and rear end portion of the base unit 11 along the guide rails on its back surface.

By sliding the display unit 12 toward the front end portion of the base unit 11 so that the lower end portion of the display unit 12 reaches the front end portion of the base unit 11 in the state in FIG. 2, the computer 10 can be set in the photography mode or tablet mode. Also, by standing the display unit 12 while lifting the upper end of the display unit 12 in the state in FIG. 2, the computer 10 can be set in the laptop mode.

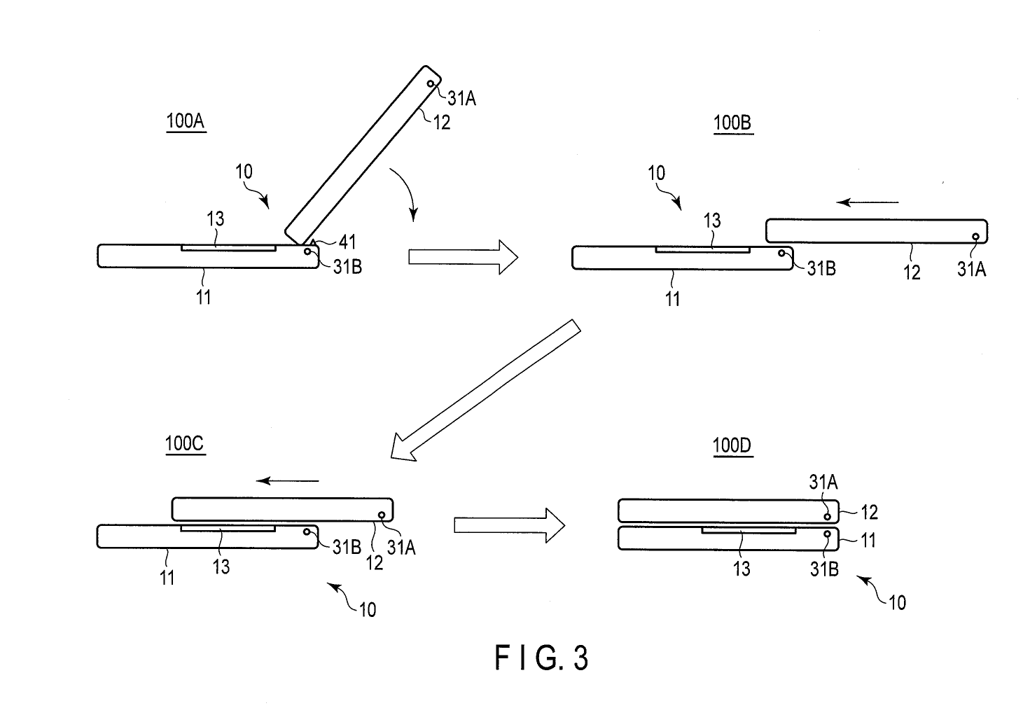

FIG. 3 shows the style transition processes of the computer 10 from the laptop mode to the tablet mode. Referring to FIG. 3, reference numeral 100A denotes a state in the aforementioned laptop mode. Reference numeral 100B denotes a state in which the display unit 12 of the computer 10 in the laptop mode is opened through nearly 180°. In the state 100B as well, a part of the upper surface of the base unit 11 is covered with the back surface of the display unit 12. Therefore, the state 100B can also be handled as one type of the photography mode. Reference numeral 100C denotes a state (photography mode) in which a part (palm rest region) of the upper surface of the base unit 11 is exposed by sliding the display unit 12, which is opened through nearly 180°, toward the front end portion of the base unit 11, and the remaining portion of the upper surface is covered with the back surface of the display unit 12. Reference numeral 100D denotes a state of the aforementioned tablet mode.

By opening the display unit 12 through nearly 180° in the state 100A, the computer 10 can transit to the state 100B. By sliding the display unit 12 toward the front end portion of the base unit 11 in the state 100B, the computer 10 can transit to the state 100C. By further sliding the display unit 12 toward the front end portion of the base unit 11 in the state 100C, the computer 10 can transit to the state 100D.

By sliding the display unit 12 toward the rear end portion of the base unit 11 in the state 100D, the computer 10 can transit to the state 100C. By sliding the display unit 12 toward the rear end portion of the base unit 11 in the state 100C, the computer 10 can transit to the state 100B. By standing the display unit 12 by lifting the upper end of the display unit 12 in the state 100B, the computer 10 can transit to the state 100A.

Switching between the laptop mode and another mode (tablet mode or photography mode) can be detected using a state detection sensor. The state detection sensor functions as a sensor configured to detect a change in setting position of the display unit 12 from the aforementioned first position to the aforementioned second position.

As this state detection sensor, a hardware switch 41 arranged on the rear end portion of the upper surface of the base unit 11 can be used. In the state 100A, the hardware switch 41 is turned off. In the states 100B, 100C, and 100D, the hardware switch 41 is turned on. By checking the state of this hardware switch 41, whether the computer 10 is in the laptop mode or another mode (tablet mode or photography mode) can be detected.

Alternatively, in addition to the hardware switch 41, a hall element (magnetic sensor) 31B or the like, which is arranged in the base unit 11 that opposes the rear end portion of the upper surface of the base unit 11 may be used. A magnet (magnetic member) 31A is arranged on the upper end portion of the back surface of the display unit 12. The hall element (magnetic sensor) 31B can detect whether or not the magnet (magnetic member) 31A comes close to the hall element (magnetic sensor) 31B, that is, whether or not the computer 10 is in the tablet mode (state 100D).

When the hardware switch 41 alone is used as the state detection sensor, and when the hardware switch 41 is OFF, it is determined that the computer 10 is in the laptop mode. On the other hand, when the hardware switch 41 is ON, it is determined that the computer 10 is in the photography mode or tablet mode.

When both the hardware switch 41 and hall element (magnetic sensor) 31B are used as the state detection sensor, one of the laptop mode, photography mode, and tablet mode of the computer 10 can be determined based on a combination of the outputs of the hardware switch 41 and hall element (magnetic sensor) 31B. For example, when the hardware switch 41 is OFF, it is determined that the computer 10 is in the laptop mode. When the hardware switch 41 is ON and the hall element (magnetic sensor) 31B is OFF, it is determined that the computer 10 is in the photography mode. When the hall element (magnetic sensor) 31B is ON, it is determined that the computer 10 is in the tablet mode.

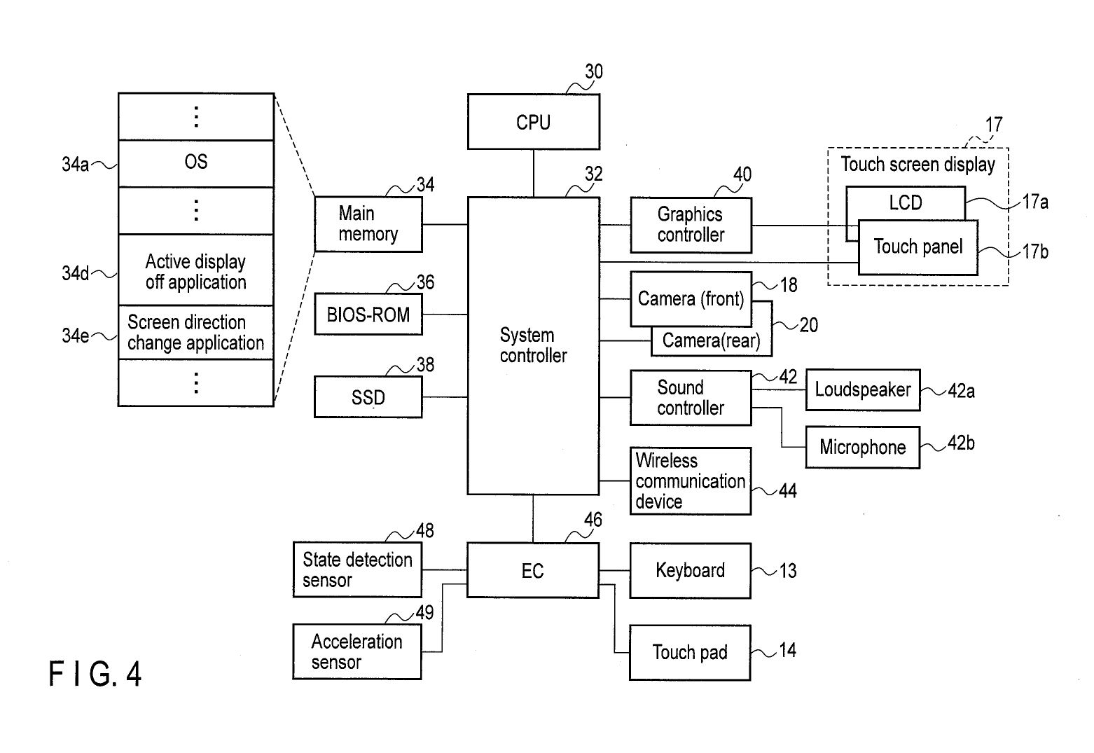

FIG. 4 shows the system arrangement of the computer 10.

As shown in FIG. 4, the computer 10 includes a CPU 30, system controller 32, main memory 34, BIOS-ROM 36, SSD (Solid State Drive) 38, graphics controller 40, sound controller 42, wireless communication device 44, EC (embedded controller) 46, state detection sensor 48, acceleration sensor (three-dimensional acceleration sensor) 49, and the like.

The CPU 30 is a processor which controls operations of various modules incorporated in the computer 10. The CPU 30 executes various software programs loaded from the SSD 38 as a nonvolatile storage device onto the main memory 34. These software programs include an OS (Operating System) 34a, active display OFF application program 34d, screen direction change application program 34e, and the like.

The active display OFF application program 34d implements the aforementioned active display OFF function. The active display OFF application program 34d judges whether or not the user watches the display 17 using a function of detecting a face from an image captured by the camera 18, and positively shifts the system to a state in which the display 17 is turned off in response to that the user leaves a seat. Also, the active display OFF application program 34d can automatically turn on the display 17 when the user sits on the seat.

That is, the active display OFF application program 34d detects the face of the user who faces the display 17 of the computer 10 using the camera 18. When the display 17 is in an ON state, and it is determined that the computer 10 is not in use, the active display OFF application program 34d controls the display 17 to transit from the ON state to an OFF state. When the display 17 is in the OFF state, and the user's face is detected, the active display OFF application program 34d controls the display 17 to transit from the OFF state to the ON state.

The screen direction change application program 34e determines whether the current mode of the computer 10 is the laptop mode or another mode (tablet mode or photography mode). When the computer 10 is in the tablet mode or photography mode, the screen direction change application program 34e executes screen rotation processing for rotating a screen image on the display 17 according to an orientation of the display unit 12 with respect to a direction of gravity. In this case, the screen direction change application program 34e detects a tilt of the computer 10 (that of the display unit 12 in the tablet mode or photography mode) with respect to the direction of gravity using the acceleration sensor 49, and changes the orientation of the screen image according to the tilt of the display unit 12 with respect to the direction of gravity. In other words, the orientation of the screen image is automatically changed so that the upper end side of the screen image is located above the lower end side of this screen image with respect to the gravity.

Also, the CPU 30 executes a BIOS (Basic Input/Output System) stored in the BIOS-ROM 36. The BIOS is a program required for hardware control.

The system controller 32 is a device which connects between the CPU 30 and various components. The system controller 32 also incorporates a memory controller which controls accesses to the main memory 34. To the system controller 32, the BIOS-ROM 36, SSD 38, graphics controller 40, sound controller 42, wireless communication device 44, EC 46, state detection sensor 48, acceleration sensor 49, and the like are connected in addition to the camera 18 and main memory 34.

The graphics controller 40 controls an LCD 17a used as a display monitor of the personal computer 10. The graphics controller 40 transmits a display signal to the LCD 17a under the control of the CPU 30. The LCD 17a displays a screen image based on the display signal. A touch panel 17b is arranged on the display surface of the LCD 17a. The touch panel 17b is, for example, an electrostatic capacitance-type sensor configured to allow the user to make inputs on the screen of the LCD 17a.

The sound controller 42 is a controller configured to process an audio signal, and controls an audio output by a loudspeaker 42a and an audio input from a microphone 42b.

The wireless communication device 44 is a device configured to execute wireless communications such as a wireless LAN or 3G mobile communications or close proximity wireless communications such as NFC (Near Field Communications).

The EC 46 is a one-chip microcomputer including controller for power management. The EC 46 has a function of turning on/off the computer 10 in response to an operation of a power button by the user. Also, the EC 46 controls inputs from the keyboard 20 and touch pad 22. The state detection sensor 48 is a sensor configured to detect the mode of the computer 10. The acceleration sensor 49 is a sensor configured to detect the orientation and motion of the computer 10. The acceleration sensor 49 detects, for example, one of landscape and portrait states of the touch screen display 17 when the user holds the personal computer 10 in the tablet mode. By detecting the orientation of the touch screen display 17 using the acceleration sensor 49, the orientation of a screen image to be displayed on the touch screen display 17 can be changed.

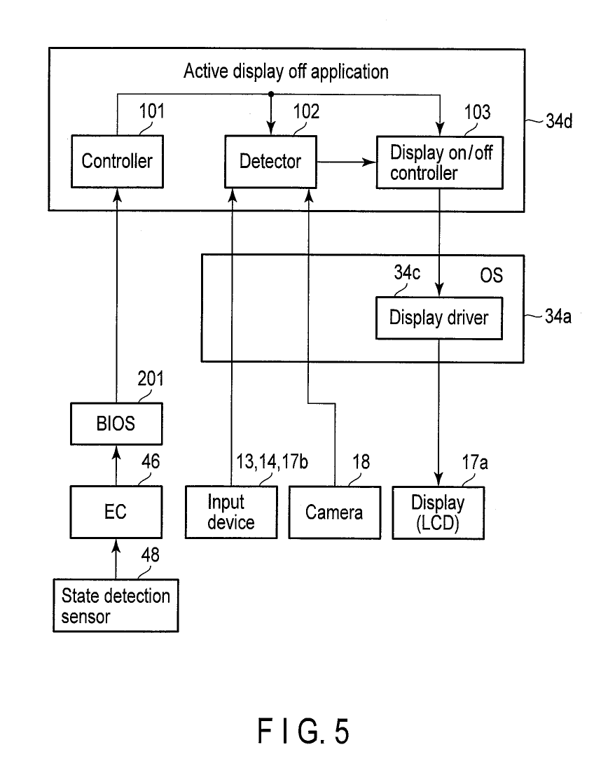

FIG. 5 shows the configuration of the active display OFF application program 34d.

The active display OFF application program 34d includes a controller 101, detector 102, and display ON/OFF controller 103. The detector 102 is configured to detect whether or not a person is in front of the screen of the display 17. The detector 102 activates the camera 18, receives an image captured by this camera 18 via the OS 34a, and analyzes that image, thereby detecting a face image of the person in that image. Furthermore, the detector 102 monitors inputs from an input device (human interface device (HID)). The HID includes the keyboard 13, touch pad 14, the touch panel 17b, and the like. The HID input monitoring operation is executed to reduce power consumption of the camera 18 by optimizing an execution timing of face detection processing using the camera 18. Immediately after an input from the HID is detected, it is easily understood that the person is in front of the computer 10 without executing the face detection processing. For this reason, the face detection processing is started after an elapse of a predetermined period since an input from the HID ceases to be detected. Then, this face detection processing is periodically executed at predetermined time intervals.

The display ON/OFF controller 103 functions as a display state controller which controls the state of the display 17 to transit from the ON state to the OFF state based on the detection result of the detector 102. After it is detected that no person is in front of the display 17, that is, after no face image is detected, the display ON/OFF controller 103 controls the state of the display 17 to transit from the ON state to the OFF state using a display driver 34c. In this case, the display ON/OFF controller 103 may power off the display 17, or may set the display 17 in a power saving state in which no image is displayed on the screen. Furthermore, when it is detected that a person is in front of the screen of the display 17 while the display 17 in the OFF state, that is, when a face image is detected, the display ON/OFF controller 103 controls the state of the display 17 to transit from the OFF state to the ON state using the display driver 34c.

In response to a change in setting position of the housing of the display unit 12 from the laptop mode to another mode (photography mode or tablet mode), the controller 101 automatically disables the aforementioned active display OFF function, and inhibits transition of the state of the display 17 based on the aforementioned face image detection result. That is, when the display unit 12 is set at the aforementioned first position (laptop mode), the controller 101 enables the active display OFF function; when the display unit 12 is set at the aforementioned second position (photography mode or tablet mode), it disables the active display OFF function.

A BIOS 201 acquires the detection output of the state detection sensor 48 from the EC 46. When the detection output of the state detection sensor 48 has changed, the BIOS 201 transmits a state (mode) change event indicating the current detection output of the state detection sensor 48 to the controller 101. The controller 101 determines the mode to which the computer 10 transits based on the state (mode) change event. When the computer 10 transits to the mode (photography mode or tablet mode) other than the laptop mode, the controller 101 controls the detector 102 and display ON/OFF controller 103 to automatically disable the active display OFF function. When the computer 10 transits to the laptop mode, the controller 101 controls the detector 102 and display ON/OFF controller 103 to automatically enable the active display OFF function.

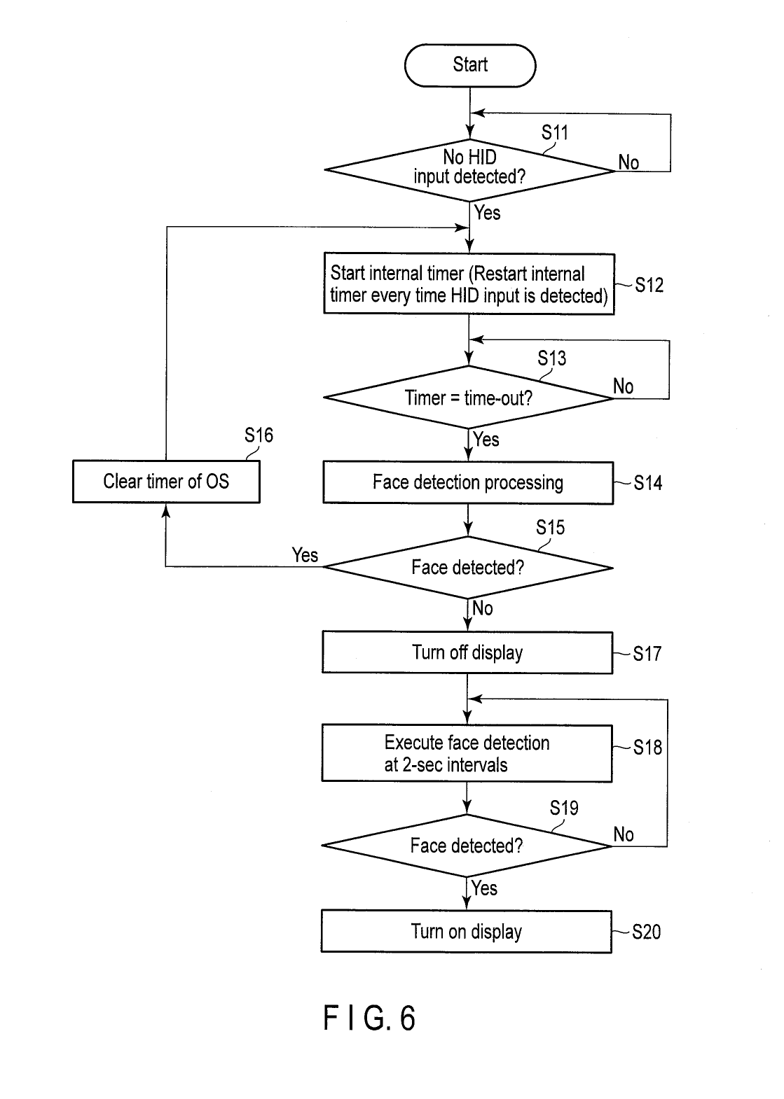

The flowchart of FIG. 6 shows the sequence of display state control processing executed by the active display OFF application program 34d.

The active display OFF application program 34d monitors an input from the HID to determine whether or not an input from the HID ceases to be detected (step S11). If an input from the HID ceases to be detected, the active display OFF application program 34d starts an internal timer so as to measure an elapsed time since the input from the HID ceases to be detected (step S12). In step S12, if an input from the HID is detected, the internal timer is restarted. If a predetermined time period has elapsed since the input from the HID ceases to be detected (timer time-out) (YES in step S13), the active display OFF application program 34d executes face detection processing (step S14). Note that the predetermined time period is decided based on a time period used in a display OFF function included in a power option function of the OS 34a. The time period used in the display OFF function indicates how many minutes since the input from the HID ceases to be detected the display is to be turned off. The predetermined time period is set to be a time period shorter than a minimum time period that can be used in the display OFF function, for example, a time period corresponding to a half of the minimum time period that can be used in the display OFF function of the OS 34a.

In step S14, the active display OFF application program 34d activates the camera 18 first. Then, the active display OFF application program 34d analyzes an image captured by the camera 18, and detects whether or not this image includes a human face image.

If a face image is detected from the image captured by the camera 18 (YES in step S15), the active display OFF application program 34d clears a timer of the OS 34a so as to prevent the display from being turned off by the display OFF function of the OS 34a (step S16). This timer of the OS 34a is used to measure an elapsed time since the input from the HID ceases to be detected. After that, the process returns to step S12, and the active display OFF application program 34d restarts its internal timer. In this manner, while the person is in front of the computer 10, that is, during a period in which the display 17 is in the ON state, the face detection processing is executed at given time intervals.

If a face image is not detected at all for, for example, 10 sec in the face detection processing in step S14, the active display OFF application program 34d determines that the image captured by the camera 18 does not include any face image (NO in step S15). In this case, the active display OFF application program 34d controls the display 17 (more specifically, the LCD 17a) to transit from the ON state to the OFF state (step S17).

During a period in which the display 17 is in the OFF state, the active display OFF application program 34d repeats the face detection processing at, for example, 2-sec intervals, so as to check whether or not a person is in front of the screen of the display 17 (steps S18 and S19). If a face image is detected in the face detection processing (YES in step S19), the active display OFF application program 34d controls the display (more specifically, the LCD 17a) to transit from the ON state to the OFF state (step S20). Then, the active display OFF application program 34d returns the process to step S11.

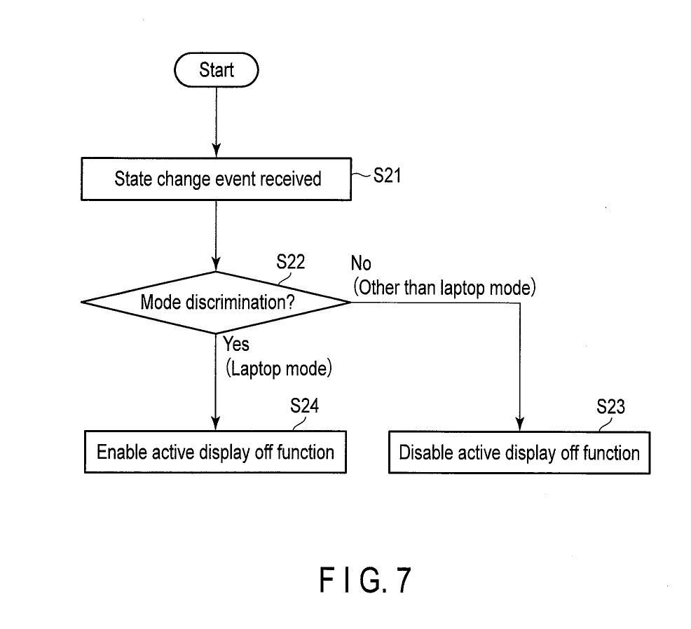

The flowchart of FIG. 7 shows the sequence of display state control enable/disable processing executed by the active display OFF application program 34d. Upon reception of a state change event from the BIOS 201 (step S21), the active display OFF application program 34d determines a mode to which the computer 10 transits based on the detection output of the state detection sensor 48 included in the state change event (step S22).

If the computer 10 transits to the mode (photography mode or tablet mode) other than the laptop mode, that is, the current mode of the computer 10 after the state change is the photography mode or tablet mode (NO in step S22), the active display OFF application program 34d disables the active display OFF function, thus inhibiting transition to the display OFF state based on the face detection result (step S23).

If the computer 10 transits to the laptop mode, that is, the current mode of the computer 10 after the state change is the laptop mode (YES in step S22), the active display OFF application program 34d enables the active display OFF function, thus permitting transition to the display OFF state based on the face detection result (step S24).

Note that the active display OFF application program 34d may have an option function of enabling the active display OFF function when a specific condition is satisfied in the mode (photography mode or tablet mode) other than the laptop mode. For example, the active display OFF function may be enabled under the condition that, for example, the computer 10 is in the tablet mode, and the screen of the display unit 12 directs nearly the horizontal direction in place of an upper or lower direction, that is, under the condition that an angle the screen of the display 17 makes with the vertical axis is not more than a first angle.

Whether or not the angle the screen of the display 17 makes with the vertical axis is not more than the first angle can be determined based on the detection output of the acceleration sensor 49.

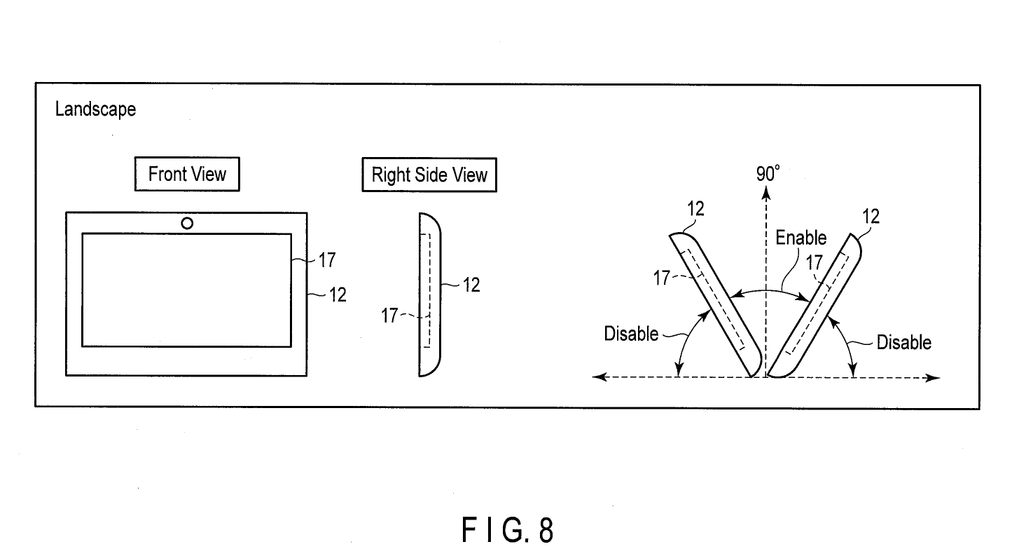

FIG. 8 shows an example of the condition under which execution of the display state control is permitted when the computer 10 is in the tablet mode. FIG. 8 assumes a case in which the computer 10 is used in the tablet mode and in the landscape mode. For example, as shown in FIG. 8, the controller 101 enables the active display OFF function under the condition that an angle the screen of the display 17 makes with the vertical axis (a broken line arrow described with 90°) is not more than a predetermined angle. Note that in the photography mode, the active display OFF function may be enabled under the condition that the screen of the display unit 12 directs nearly in the horizontal direction in place of the upper or lower direction, that is, under the condition that an angle the screen of the display 17 makes with the vertical axis is not more than the first angle.

As described above, according to this embodiment, when the display unit 12 is set at the first position (laptop mode), the control function of controlling the state of the display to transit from the ON state to the OFF state based on the detection result as to whether or not a person is in front of the screen of the display 17 is enabled. When the display unit 12 is set at the second position (tablet mode or photography mode), the aforementioned control function is disabled. Therefore, the operation of the computer 10 can be adaptively controlled according to the use state of the computer 10, and a problem that the screen of the display 17 is turned off although the user uses the computer 10 in the tablet mode or photography mode can be prevented from occurring.

Note that this embodiment has explained the case in which whether or not a person is in front of the screen of the display 17 is detected by executing the face detection processing for an image captured by the camera. Alternatively, whether or not a person is in front of the screen of the display 17 may be detected using a human sensor which adopts an infrared sensor or the like.

This embodiment has assumed the case in which the base unit 11 houses the CPU, memory, and various other electronic components. Alternatively, the display unit 12 may house some or all of the CPU, memory, and various other electronic components.

Note that the sequence of the operation control processing of this embodiment can be implemented by a computer program. Hence, by installing and executing this computer program in a normal convertible computer via a computer-readable storage medium that stores this computer program, the same effects as those in this embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first housing comprising an upper surface;
a keyboard on the upper surface;
a second housing comprising a front surface;
a display on the front surface;
a detector configured to detect whether a person is in front of a screen of the display; and
a controller configured to enable a control function for controlling a state of the display to transit from an ON state to an OFF state based on a detection result of the detector when the second housing is set at a first position where the screen of the display and the upper surface are exposed, and to disable the control function when the second housing is set at a second position where the screen of the display is exposed and at least a part of the upper surface is covered with a back surface of the second housing.

2. The information processing apparatus of claim 1, wherein after the detector detects that no person is in front of the screen of the display, the control function controls the state of the display to transit from the ON state to the OFF state, and when the detector detects that a person is in front of the screen of the display while the display is in the OFF state, the control function controls the state of the display to transit from the OFF state to the ON state.

3. The information processing apparatus of claim 1, further comprising a camera on the front surface of the second housing, wherein the detector detects whether a person is in front of the screen of the display by detecting a face image of the person in an image captured by the camera.

4. The information processing apparatus of claim 1, wherein the second position comprises a third position where the screen of the display is exposed and the upper surface is fully covered with the back surface of the second housing.

5. The information processing apparatus of claim 1, further comprising a touch pad on a front end portion on the upper surface,
wherein the second position comprises a fourth position where the screen of the display is exposed, at least the part of the upper surface is covered with the back surface of the second housing, and the touch pad on the upper surface is exposed.

6. The information processing apparatus of claim 1, wherein when the second housing is set at the second position, the controller enables the control function under a condition that an angle the screen of the display makes with a vertical axis is not more than a first angle.

7. An operation control method of an information processing apparatus, which comprises a first housing comprising an upper surface, a keyboard on the upper surface, a second housing comprising a front surface, and a display on the front surface, the method comprising:
detecting whether a person is in front of a screen of the display;
enabling a control function required to control a state of the display to transit from an ON state to an OFF state based on a detection result of the detector when the second housing is set at a first position where the screen of the display and the upper surface are exposed; and
disabling the control when the second housing is set at a second position where the screen of the display is exposed and at least a part of the upper surface is covered with a back surface of the second housing.

8. A computer-readable, non-transitory storage medium comprising a computer program configured to be executed by a computer, the computer comprising a first housing comprising an upper surface, a keyboard on the upper surface, a second housing comprising a front surface, and a display on the front surface, the computer program configured to cause the computer to execute functions of:
detecting whether a person is in front of a screen of the display;
enabling a control function required to control a state of the display to transit from an ON state to an OFF state based on a detection result of the detector when the second housing is set at a first position where the screen of the display and the upper surface are exposed; and
disabling the control function when the second housing is set at a second position where the screen of the display is exposed and at least a part of the upper surface is covered with a back surface of the second housing.
